(19) United States
(12) Patent Application Publication
(10) Pub. No.: US 2008/0138504 A1
(43) Pub. Date: Jun. 12, 2008

(54) COATINGS FOR COMPONENTS OF SEMICONDUCTOR WAFER FABRICATION EQUIPMENT

(75) Inventor: Steven C. Williams, Beaverton, OR (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: CoorsTek, Inc., Golden, CO (US)

(21) Appl. No.: 11/925,673

(22) Filed: Oct. 26, 2007

Related U.S. Application Data
(60) Provisional application No. 60/869,202, filed on Dec. 8, 2006.

(51) Int. Cl. B05D 5/12; B05C 13/00

(52) U.S. Cl. 427/96.2; 118/500

(57) ABSTRACT

A method of forming a high wear resistance coating on a substrate having a low coefficient of thermal expansion is described. The method may include providing the low CTE substrate, where a surface of the substrate includes a plurality of protrusions raised above the surface. A high wear resistance layer is formed on a top portion of protrusions, where the layer is not contiguous between adjacent protrusions on the substrate. Also, a wafer support component to support a wafer during, for example, a photolithography or inspection process. The wafer support component includes a substrate that has a material with a low coefficient of thermal expansion, where the substrate has a surface with a plurality of protrusions raised about the surface. A high wear resistance layer is formed on a top surface of each of the protrusions.

### CROSS-REFERENCES TO RELATED APPLICATIONS

This application claims the benefit of U.S. Provisional Application No. 60/869,202, filed Dec. 8, 2006, entitled “COATINGS FOR COMPONENTS OF SEMICONDUCTOR WAFER FABRICATION EQUIPMENT,” the entire contents of which is herein incorporated by reference for all purposes.

### BACKGROUND OF THE INVENTION

Integrated circuit chip fabrication generally involves printing features on a substrate wafer using photolithography techniques. During the photolithography process, the position of the wafer substrate relative to imaging system needs to be very precise, requiring the substrate support to be built and maintained to sub-micron tolerances. In operation, the slightest temperature gradients generated by the environment or process can have detrimental effects on the process quality due to the substrate and substrate support thermally generated expansion. The sensitivity to slight temperature gradients causing sub-micron dimensional and geometric tolerances can limit the materials used to make the wafer support to materials with relatively low thermal expansion characteristics over the temperature range of operation. These materials include glass ceramics with low coefficients of thermal expansion (CTE) such as Zerodur® made by Schott Inc., ULE™ Zero Expansion Glass made by Corning, Inc., and modified forms of cordierite (2MgO.2Al₂O₄.5SiO₂), among other low CTE materials.

Unfortunately, some of the preferred low CTE materials, such as Zerodur®, are very expensive and are also relatively soft which makes them prone to wear. The wear is caused by the placement of the substrate wafer placed on the wafer support and the abrasion at the interface between the wafer and the support. The wafer support typically is a low contact surface made up of an array of small protrusions. The surface area of contact is low to minimize the effect of backside particle contamination affecting the top side geometry. However, the low surface area of contact makes this design especially prone to wear. With the tight dimensional tolerances required in may wafer fabrication operations, wafer supports made from these materials can require replacement after only a few months of use. Thus, there is a need either to find new materials that have both low CTEs and high wear resistance, or to find ways to make the existing materials more wear resistant without compromising there low CTE characteristics.

One way to improve the wear resistance of materials like Zerodur® is to coat them with a high wear resistance film. However, care has to be taken in how the film is applied, because such films typically have CTEs that are significantly higher than Zerodur®. Moreover, the coatings need to be applied by processes that do not exceed the thermal budget of the low CTE material. For example, heating Zerodur® to temperatures above 1000° C. to form the high wear resistance coating may cause a phase change in the Zerodur® itself that raises its CTE. Thus, there is a need for coating methods that form high wear resistance films on selected portions of low CTE materials at temperatures that do not degrade the CTE properties of those materials. Solutions to these and other problems with coating low CTE materials are addressed by the present invention.

### BRIEF SUMMARY OF THE INVENTION

Embodiments of the invention include methods of forming a high wear resistance coating on a substrate having a low coefficient of thermal expansion. The methods may include the step of providing the low CTE substrate, where a surface of the substrate comprises a plurality of protrusions raised above the surface. The methods may further include forming a high wear resistance layer on a top portion of protrusions, where the layer is not contiguous between adjacent protrusions on the substrate.

Embodiments of the invention may also include methods of forming a discontinuous silicon carbide layer on a Zerodur substrate used as a wafer support. The methods may include the step of providing the Zerodur substrate, where a surface of the substrate includes a plurality of protrusions raised above the surface. The methods may also include polishing top portions of the protrusions, and contacting the Zerodur substrate with an acid etchant. The methods may still further include aligning a deposition mask between an ion beam source and the Zerodur substrate, where the mask is aligned to allow the silicon carbide layer to form on the protrusions. The silicon carbide layer may be formed on the top portions, and a portion of at least one side of the protrusions, with an ion beam deposition performed at a temperature of about 100° C. or less. The mask pattern keeps the silicon carbide layer from being contiguous between adjacent protrusions on the substrate.

Embodiments of the invention still further include wafer support components to support a wafer in a wafer processing chamber. The wafer support components may include a substrate comprising a material with a low coefficient of thermal expansion, where the substrate has a surface with a plurality of protrusions raised about the surface. The components may also include a high wear resistance layer formed on a top surface of each of the protrusions.

Additional embodiments and features are set forth in part in the description that follows, and in part will become apparent to those skilled in the art upon examination of the specification or may be learned by the practice of the invention. The features and advantages of the invention may be realized and attained by means of the instrumentalities, combinations, and methods described in the specification.

### BRIEF DESCRIPTION OF THE DRAWINGS

A further understanding of the nature and advantages of the present invention may be realized by reference to the remaining portions of the specification and the drawings wherein like reference numerals are used throughout the several drawings to refer to similar components. In some instances, a sublabel is associated with a reference numeral and follows a hyphen to denote one of multiple similar components. When reference is made to a reference numeral without specification to an existing sublabel, it is intended to refer to all such multiple similar components.

FIG. 1 is a flowchart illustrating steps in methods of forming a high wear resistance coating on a low CTE substrate according to embodiments of the invention;

FIG. 2 is a flowchart illustrating steps in additional methods of forming a high wear resistance coating on a low CTE substrate according to embodiments of the invention;

FIG. 3A-C are simplified cross-sectional profiles of a raised protrusion on a portion of a substrate where a high wear resistance layer is formed on the protrusion according to embodiments of the invention;

FIG. 4 is a simplified cross-sectional profile of a series of raised protrusions shown on a portion of a substrate according to embodiments of the invention;

FIG. 5 is a simplified cross-sectional profile of a wafer support component for a wafer processing or inspection system according to embodiments of the invention;

FIG. 6 is an image of a high wear resistance SiC layer formed over a protrusion in a Zerodur substrate according to embodiments of the invention;

FIG. 7 is a image of a high wear resistance SiC layer formed over a plurality of protrusions in a Zerodur substrate according to embodiments of the invention;

FIG. 8 is a image of a high wear resistance SiC layer formed over an array of protrusions in a rectangular shaped Zerodur substrate according to embodiments of the invention; and

FIG. 9 is an image of a wafer support component according to embodiments of the invention.

### DETAILED DESCRIPTION OF THE INVENTION

The present invention relates to wafer support components (e.g., a wafer chuck) for wafer fabrication devices, and methods of making those components. The wafer support components are made from a substrate with raised protrusions that contact and support a precise position of the wafer during a wafer processing operation. The substrate includes one or more materials having low coefficients of thermal expansion (CTEs) that do not significantly expand and/or contract during a processing operation. Because many of the low CTE substrate materials used are relatively soft and can wear down rapidly (e.g., 2-3 months) during repeated use, a high wear resistance layer is formed on the protrusions to reduce the wear rate of the component. A high wear resistance layer is a layer having a solid surface that resists erosion and/or dimensional change from frictional contact with another solid surface. The high wear resistance layer can extend the lifetime of a wafer support component by two, three, four, five, and six or more times that of a component with just a bare substrate.

The high wear resistance layer may be a discontinuous layer with discrete coverage on and around the top surface of the substrate protrusions. Complete coverage of the low CTE substrate with a continuous, blanket layer of the high wear resistance material is usually not done, because a blanket layer can increase the overall CTE of the component. By limiting the high wear resistance layer only on and around the protrusions, the change in the overall CTE of the component is negligible.

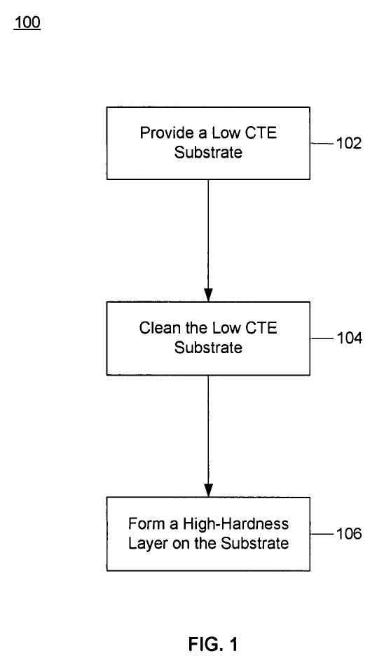

Referring now to FIG. 1, a flowchart that outlines some of the steps in exemplary methods of making wafer substrate components according to embodiments of the invention is shown. The method 100 may start with providing a substrate of low CTE material 102 that has a surface dotted with a plurality of protrusions that extend out from the surface. These protrusions may be thought of as pins that contact and support a wafer during a wafer processing operation.

The low CTE material that is used to make the substrate may include one or more materials with a measured CTE of 1.0×10⁻⁶ K⁻¹ or less, 0.5×10⁻⁶ K⁻¹ or less, 0.1×10⁻⁶ K⁻¹ or less, 0.05×10⁻⁶ K⁻¹ or less, or 0.01×10⁻⁶ K⁻¹ or less, at room temperature (i.e., about 23° C.). Examples of these materials may include, without limitation, low CTE glass ceramics, cordierite and modified cordierites, metal silicate glasses, titanium silicate glasses, the Zerodur® family of materials made by Shott, Inc., and the ULE™ Zero Expansion Glass family of materials made by Corning, Inc., among other materials.

The substrate may be cleaned 104 before the high wear resistance layer is deposited. The cleaning may include polishing the whole surface of the substrate with the protrusions, or just the top surfaces of the protrusions. A polishing slurry may be used to polish the surface. The surface may be polished to an average surface roughness of about 1 to about 2 nm root mean squared (RMS).

The cleaning step 104 may also include contacting the substrate surface with an acid etchant. The acid etch may be done in addition to, or in lieu of, polishing the substrate surface. While not wanting to be bound to a particular theory, it is believed that a cleaning step 104 that includes polishing the substrate followed by exposure to acid etchant may, for some substrates, provide a more adhesive deposition surface for the high wear resistance layer. Polishing the substrate may create microcracks in the surface from the grinding of the polishing abrasives against the substrate. These cracks can cause stresses in the polished substrate surface that reduce the ability of the overlying high wear resistance layer to adhere to the stresses substrate surface. The acid etchant may help relieve at least some of these stresses, and enhance the ability of the high wear resistance layer to stick to the substrate.

Following the substrate cleaning 104, the high wear resistance layer may be formed on the substrate 106. As noted above, the high wear resistance layer is usually a discontinuous layer that is formed on and possibly around the top surfaces of the protrusions. The high wear resistance layer typically does not extend from one protrusion to the next to form a contiguous layer between adjacent protrusions.

Exemplary methods of forming the high wear resistance layer may include a deposition of the layer using an ion beam deposition process, an plasma enhanced chemical vapor deposition process, a laser deposition process, and/or a high density plasma chemical vapor deposition process, among other kinds of processes. In an ion beam deposition process, the deposition may take place at a low temperature, such as 250° C. or less, or 50° C. or less. For some substrate materials a low temperature deposition is advantageous because it reduces the risk of increasing the CTE of the substrate due to high temperature phase changes in the low CTE material. The ion beam process typically deposits a high wear resistance layer of about 1 to about 10 μm in thickness. Plasma enhanced chemical vapor deposition processes are typically done at about 100° C. to about 150° C. (e.g., about 120° C.) and deposit a high wear resistance layer of up to and including about 100 μm in thickness. A laser deposition process may be used to deposit a diamond-like-carbon layer on the substrate.

The high wear resistance layer may be made from a variety of high wear resistance materials, including without limitation, silicon carbide, silicon nitride, aluminum oxide, diamond-like carbon, titanium nitride, zirconium nitride, or tungsten carbide. The type of high wear resistance material may depend on the low CTE material used for the underlying substrate.

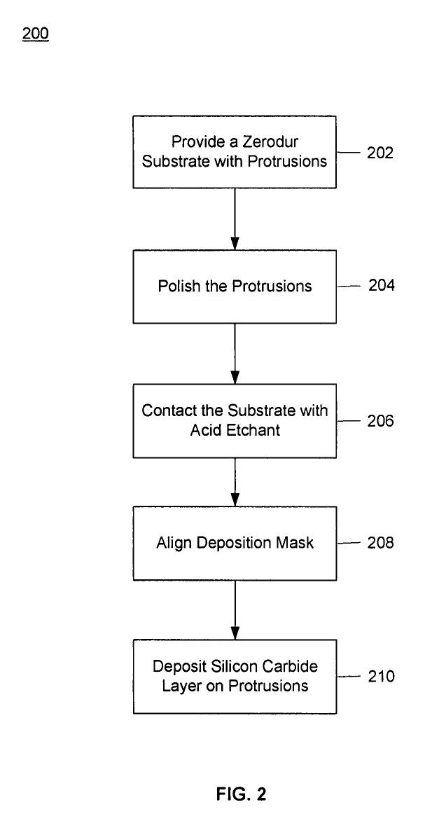

FIG. 2 is a flowchart showing steps in an exemplary method 200 of forming a high wear resistance coating on a low CTE substrate according to embodiments of the invention. The method 200 includes providing a Zerodur® substrate 202 having protrusions extending from a relatively planar surface. The substrate is polished 204 so that top surfaces of the protrusions have an average roughness of about 1 to 2 nm RMS. The polished substrate is then exposed to an acid etchant 206, and may also undergo additional pretreatment steps.

The pretreated substrate is then placed in an ion beam deposition chamber where a deposition mask is aligned 208 to allow a high wear resistance silicon carbide layer to be formed on the top surfaces of the protrusions. The ion beam deposition deposits a layer of silicon carbide on the protrusions 210, but the mask prevents any significant deposition of the SiC on the substrate surface between the protrusions. The SiC deposition occurs at a temperature of about 50° C., which is well below the temperature range in which the Zerodur® substrate may undergo a phase change to a material having a higher CTE (e.g., 600° C. to 700° C. or more).

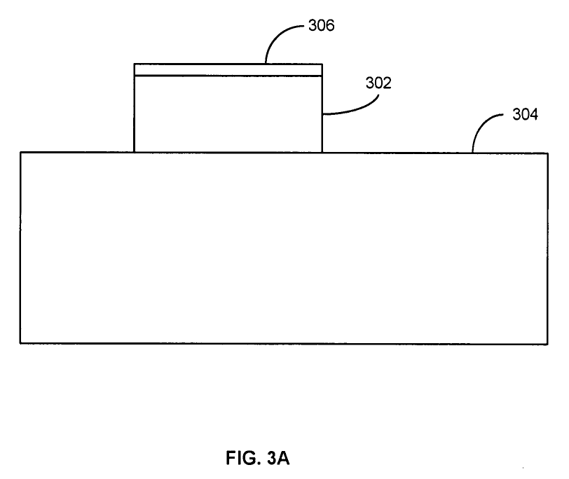

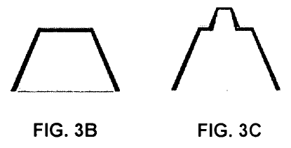

Referring now to FIGS. 3A-C, simplified cross-sectional profiles of a raised protrusion on a portion of a substrate where a high wear resistance layer is formed on the protrusion according to embodiments of the invention are shown. The profile in FIG. 3A shows a rectangular shaped protrusion 302 projected up from a planar top surface of substrate 304. FIGS. 3B & C show alternate embodiments where the protrusion has a trapezoidal shape (FIG. 3B) and a second trapezoidal protrusion formed on a top surface of a first trapezoidal protrusion (FIG. 3C). Additional cross-sectional shapes of protrusions are also contemplated, including without limitation, a square, conical or pyramidal shaped profile. A substrate with two or more different protrusion profiles is also possible. In the embodiment shown, the height of the protrusion may be about 0.25 mm above the top surface of the substrate 304, but the height of the protrusions can vary depending on the intended application of the component.

A high wear resistance layer 306 is formed on the top surface of the protrusion 302. In the embodiment shown, the layer has a thickness of about 10 μm, but this can vary depending on the intended application of the component, and the deposition method used. The embodiment also shows the high wear resistance layer 306 only covering a planer top surface of the protrusion 302 without extension down the adjacent sidewalls. Additional embodiments (not shown) have a high wear resistance layer at least partially extending down one or more sides adjacent to the top surface of the protrusion. In some instances, the high wear resistance layer may extend all the way to the surface of the substrate 304.

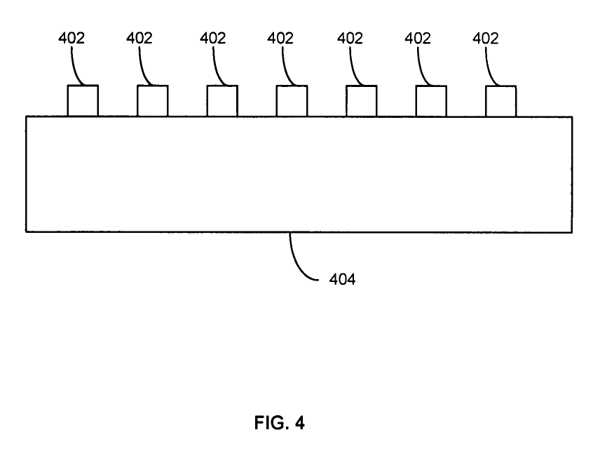

FIG. 4 shows a simplified cross-sectional profile of a series of raised protrusions shown on a portion of a substrate according to embodiments of the invention. The protrusions 402 are equally spaced on substrate 404 and have a square cross-sectional profile. As noted before, the protrusions may have shapes other than rectangular or square cross-sectional profiles (e.g., conical, trapezoidal, pyramidal, etc). Additional embodiments may also include an unequal spacing of the protrusions.

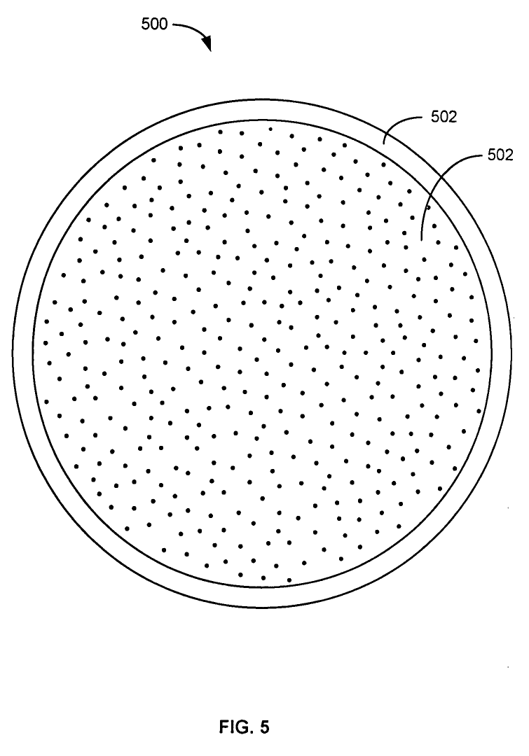

FIG. 5 shows a simplified cross-sectional profile of a wafer support component (i.e., a wafer chuck) for a wafer processing or inspection system according to embodiments of the invention. The support 500 shown is circular, and includes an array of symmetrically spaced protrusions 502 surrounded by a smooth annular perimeter 504. The wafer (not shown) may be placed on top of component 500, where the protrusions 502 make contact and support the wafer in a precise position above the component. A vacuum may be created in the space between the protrusions to help hold the wafer in place on the support 500.

Support 500 is shaped similar to a 200 or 300 mm circular wafer that is conventional in the semiconductor industry. However, a support may have other shapes (not shown) including rectangular or square, among other shapes. In addition, the protrusions in area 502 are arranged in a square array. Other arrangements, including a circular or elliptical array, and/or arrays were the protrusions are variably spaced with respect to each other are also contemplated.

The wafer support component 500 may be used in a variety of processes and chambers related to wafer fabrication and inspection processes. For example, the component 500 may be used to support a wafer in a semiconductor lithography process. The component 500 may also be used to support a wafer during a wafer inspection process. Additional processes are also contemplated.

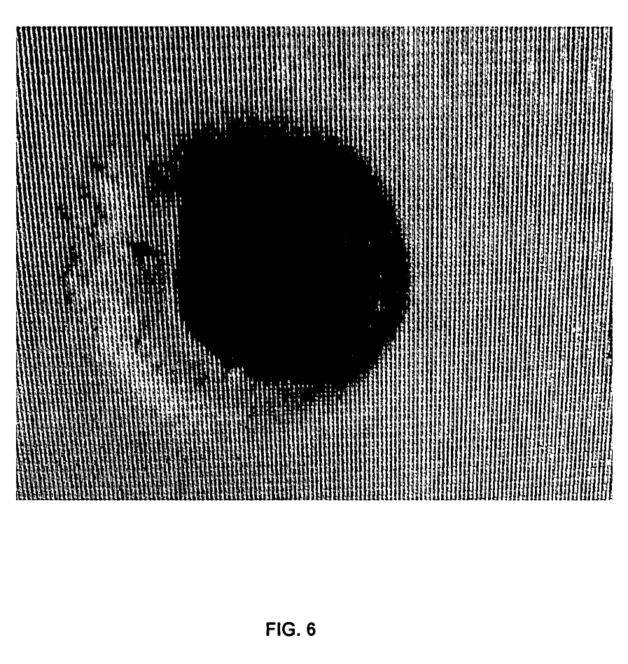

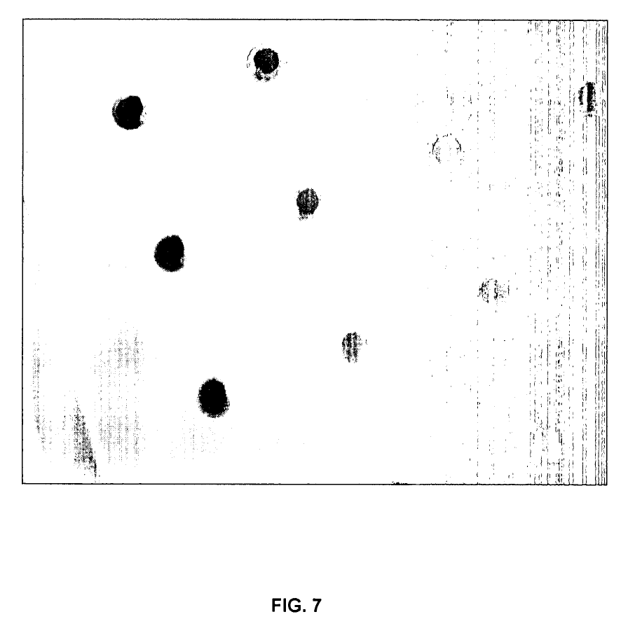

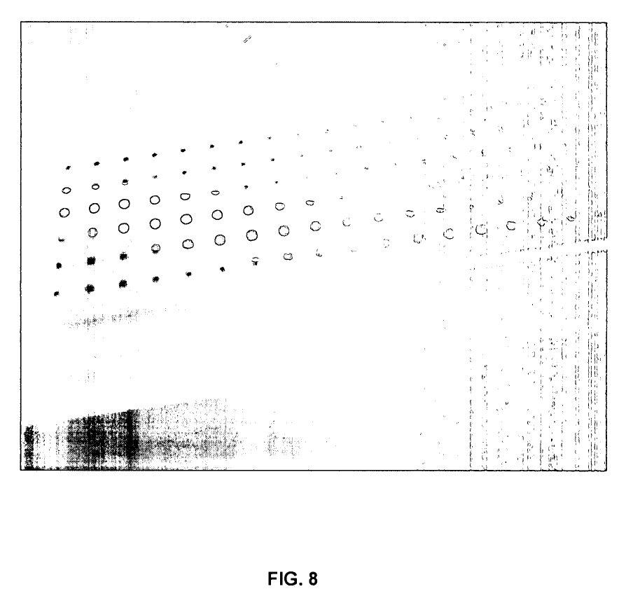

FIGS. 6-8 show images of a high wear resistance SiC layer formed over protrusions in a Zerodur® substrate according to embodiments of the invention. FIG. 6 is a magnified image of a bird's-eye view of a single SiC coated protrusion. FIG. 7 shows a portion of the SiC coated Zerodur substrate where the dark circular shaped areas at the tops of the protrusions are the SiC layer. Finally, FIG. 8 shows the entire rectangular Zerodur substrate with a rectangular array of protrusions on which the SiC layer is formed.

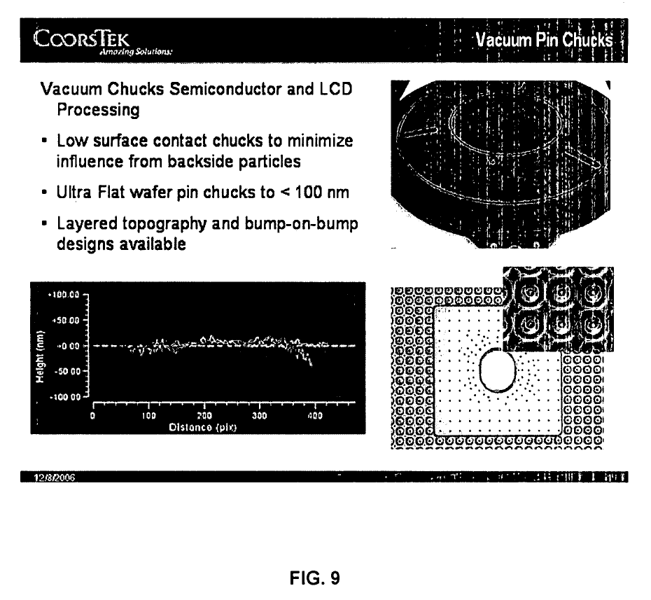

FIG. 9 shows an image of a wafer support component according to embodiments of the invention. The wafer component shown in this embodiment may be a vacuum chuck used in a semiconductor and/or LCD processing system. The protrusions (or pins) on the surface of the component in contact with the wafer create a lower surface contact area between the wafer and the chuck than if the contact surface of the chuck was flat. The magnified image of a portion of the chuck surface show that the protrusions have a “bump-on-bump” cross-sectional shape similar to that shown in FIG. 3C above. The high wear resistance coating may cover the top surface of the top bump, or it may extend down the side of the protrusion and cover exposed sections of the lower bump as well.

Having described several embodiments, it will be recognized by those of skill in the art that various modifications, alternative constructions, and equivalents may be used without departing from the spirit of the invention. Additionally, a number of well known processes and elements have not been described in order to avoid unnecessarily obscuring the present invention. Accordingly, the above description should not be taken as limiting the scope of the invention.

Where a range of values is provided, it is understood that each intervening value, to the tenth of the unit of the lower limit unless the context clearly dictates otherwise, between the upper and lower limits of that range is also specifically disclosed. Each smaller range between any stated value or intervening value in a stated range and any other stated or intervening value in that stated range is encompassed. The upper and lower limits of these smaller ranges may independently be included or excluded in the range, and each range where either, neither or both limits are included in the smaller ranges is also encompassed within the invention, subject to any specifically excluded limit in the stated range. Where the stated range includes one or both of the limits, ranges excluding either or both of those included limits are also included.

As used herein and in the appended claims, the singular forms “a”, “an”, and “the” include plural referents unless the context clearly dictates otherwise. Thus, for example, reference to “a process” includes a plurality of such processes and reference to “the material” includes reference to one or more materials and equivalents thereof known to those skilled in the art, and so forth.

Also, the words “comprise,” “comprising,” “include,” “including,” and “includes” when used in this specification and in the following claims are intended to specify the presence of stated features, integers, components, or steps, but they do not preclude the presence or addition of one or more other features, integers, components, steps, acts, or groups.

1. A method of forming a high wear resistance coating on a substrate having a low coefficient of thermal expansion, the method comprising:
providing the low CTE substrate, wherein a surface of the substrate comprises a plurality of protrusions raised above the surface;
forming a high wear resistance layer on a top portion of protrusions, wherein the layer is not contiguous between adjacent protrusions on the substrate.

2. The method of claim 1, wherein the high wear resistance layer is formed on the substrate at a temperature that is less than a phase transition temperature of the substrate.

3. The method of claim 1, wherein the method includes polishing the protrusions before forming the high wear resistance layer on the top portions of the protrusions.

4. The method of claim 1, wherein a top surface of the protrusions are polished to a surface an average surface roughness of about 1 to about 2 nm root mean squared.

5. The method of claim 1, wherein the method includes performing an acid etch on the protrusions before forming the high wear resistance layer on the top portions of the protrusions.

6. The method of claim 1, wherein the protrusions have a substantially square, rectangular, conical, or trapezoidal cross-sectional profile.

7. The method of claim 1, wherein the top portion of the protrusions comprise a top surface that is substantially parallel to the surface of the substrate.

8. The method of claim 6, wherein the high wear resistance layer is formed on the top surface of the protrusions, and also extends down a portion of at least one side of the protrusion that is adjacent to the top surface.

9. The method of claim 1, wherein the high wear resistance layer is formed with an ion beam deposition process.

10. The method of claim 9, wherein the ion beam deposition process is performed at a temperature of about 250° C. or less.

11. The method of claim 9, wherein the high wear resistance layer has a thickness of about 20 μm or less.

12. The method of claim 1, wherein the high wear resistance layer is formed with a plasma enhanced chemical vapor deposition process.

13. The method of claim 12, wherein the high wear resistance layer has a thickness of about 150 μm or less.

14. The method of claim 1, wherein the high wear resistance layer is formed with a laser deposition process.

15. The method of claim 1, wherein the high wear resistance layer is formed with a high-density plasma chemical vapor deposition process which comprises both etching the substrate and depositing the high wear resistance layer.

16. The method of claim 1, wherein the low CTE substrate comprises a material having a coefficient of thermal expansion of 1.0×10⁻⁶ K⁻¹ or less at 23° C.

17. The method of claim 1, wherein the low CTE substrate comprises a material having a coefficient of thermal expansion of 0.1×10⁻⁶ K⁻¹ or less at 23° C.

18. The method of claim 1, wherein the low CTE substrate comprises a material having a coefficient of thermal expansion of 0.01×10⁻⁶ K⁻¹ or less at 23° C.

19. The method of claim 1, wherein the low CTE substrate comprises a glass ceramic.

20. The method of claim 1, wherein the low CTE substrate comprises cordierite.

21. The method of claim 1, wherein the low CTE substrate comprises a metal silicate glass.

22. The method of claim 1, wherein the low CTE substrate comprises a titanium silicate glass.

23. The method of claim 1, wherein the low CTE substrate comprises Zerodur® or ULE™ Zero Expansion Glass.

24. The method of claim 1, wherein the high wear resistance layer is made from a material comprising silicon carbide, silicon nitride, aluminum oxide, diamond-like carbon, titanium nitride, zirconium nitride, or tungsten carbide.

25. A method of forming a discontinuous silicon carbide layer on a Zerodur substrate used as a wafer support, the method comprising:
providing the Zerodur substrate, wherein a surface of the substrate comprises a plurality of protrusions raised above the surface;
polishing top portions of the protrusions;
contacting the Zerodur substrate with an acid etchant;
aligning a deposition mask between an ion beam source and the Zerodur substrate, wherein the mask is aligned to allow the silicon carbide layer to form on the protrusions;
forming the silicon carbide layer on the top portions and a portion of at least one side of the protrusions with an ion beam deposition performed at a temperature of about 100° C. or less, wherein the silicon carbide layer is not contiguous between adjacent protrusions on the substrate.

26. A wafer support component to support a wafer in a wafer processing chamber, the wafer support component comprising:
a substrate comprising a material with a low coefficient of thermal expansion, wherein the substrate has a surface with a plurality of protrusions raised about the surface; and
a high wear resistance layer formed on a top surface of each of the protrusions.

27. The wafer support component of claim 26, wherein at least a portion of the protrusions make contact with the wafer during a wafer processing operation in the processing chamber.

28. The wafer support component of claim 26, wherein the protrusions have a substantially square, rectangular, conical, or trapezoidal cross-sectional profile.

29. The wafer support component of claim 26, wherein the top portion of the protrusions comprise a top surface that is substantially parallel to the surface of the substrate.

30. The wafer support component of claim 26, wherein the high wear resistance layer is formed on the top surface of the protrusions, and also extends down a portion of at least one side of the protrusion that is adjacent to the top surface.

31. The wafer support component of claim 26, wherein the material with the low coefficient of thermal expansion has a coefficient of thermal expansion of 1.0×10⁻⁶ K⁻¹ or less at 23° C.

32. The wafer support component of claim 26, wherein the material with the low coefficient of thermal expansion has a coefficient of thermal expansion of 0.1×10⁻⁶ K⁻¹ or less at 23° C.

33. The wafer support component of claim 26, wherein the material with the low coefficient of thermal expansion has a coefficient of thermal expansion of 0.05×10⁻⁶ K⁻¹ or less at 23° C.

34. The wafer support component of claim 26, wherein the material with the low coefficient of thermal expansion has a coefficient of thermal expansion of 0.01×10⁻⁶ K⁻¹ or less at 23° C.

35. The wafer support component of claim 26, wherein the material with the low coefficient of thermal expansion comprises a glass ceramic.

36. The wafer support component of claim 26, wherein the material with the low coefficient of thermal expansion comprises cordierite.

37. The wafer support component of claim 26, wherein the material with the low coefficient of thermal expansion comprises a metal silicate glass.

38. The wafer support component of claim 26, wherein the material with the low coefficient of thermal expansion comprises a titanium silicate glass.

39. The wafer support component of claim 26, wherein the material with the low coefficient of thermal expansion comprises Zerodur® or ULE™ Zero Expansion Glass.

40. The wafer support component of claim 26, wherein the high wear resistance layer is not contiguous between adjacent protrusions on the substrate.

41. The wafer support component of claim 26, wherein the high wear resistance layer comprises silicon carbide, silicon nitride, aluminum oxide, diamond-like carbon, titanium nitride, zirconium nitride, or tungsten carbide.

42. The wafer support component of claim 26, wherein the high wear resistance layer has a thickness of about 20 μm or less.

43. The wafer support component of claim 26, wherein the high wear resistance layer has a thickness of about 150 μm or less.
